(19) United States
(12) Patent Application Publication
(10) Pub. No.: US 2012/0135290 A1
(43) Pub. Date: May 31, 2012

(54) OLIVINE-BASED POSITIVE ACTIVE MATERIAL FOR RECHARGEABLE LITHIUM BATTERY AND RECHARGEABLE LITHIUM BATTERY USING SAME

(75) Inventors: Han-Eol Park, Yongin-si (KR); Sun-Hwa Kwon, Yongin-si (KR); Ji-Hyun Kim, Yongin-si (KR); Ki-Hyun Kim, Yongin-si (KR); Yong-Chan You, Yongin-si (KR); Yoon-Chang Kim, Yongin-si (KR)

(73) Assignee: Samsung SDI Co., Ltd., Yongin-si (KR)

(21) Appl. No.: 13/241,099

(22) Filed: Sep. 22, 2011

(30) Foreign Application Priority Data
Nov. 30, 2010 (KR) 10-2010-0120872

(51) Int. Cl. H01M 4/131; H01M 2/16

(52) U.S. Cl. 429/144; 429/220; 429/221; 429/223; 429/224; 429/229; 429/231.5; 429/231.6; 429/231.95; 252/182.1

(57) ABSTRACT

Disclosed is an olivine-based positive active material for a rechargeable lithium battery and a rechargeable lithium battery using the same, wherein the olivine-based positive active material for a rechargeable lithium battery is represented the following Formula 1.

LiₓM_{y}M′_{z}XO_{4-w}B_{w} [Chemical Formula 1]

Chemical Formula 1 has the same definitions as in the specification.

### CROSS-REFERENCE TO RELATED APPLICATIONS

This application claims priority to and the benefit of Korean Patent Application No. 10-2010-0120872 filed in the Korean Intellectual Property Office on Nov. 30, 2010, the entire contents of which are incorporated herein by reference.

### BACKGROUND

1. Field

This disclosure relates to an olivine-based positive active material for a rechargeable lithium battery and a rechargeable lithium battery using the same.

2. Description of the Related Technology

Batteries for portable electronic equipment that have both high performance and large capacity are needed in the industry.

Batteries generate electrical power using an electrochemical reaction material for a positive electrode and a negative electrode. Representatively, rechargeable lithium batteries generate electrical energy from changes of chemical potential, when lithium ions are intercalated/deintercalated at the positive and negative electrodes.

The rechargeable lithium batteries include materials that reversibly intercalate or deintercalate lithium ions during charge and discharge reactions as both positive and negative active materials, and an organic electrolyte or a polymer electrolyte between the positive and negative electrodes.

For the positive active material for a rechargeable lithium battery, composite metal oxides such as LiCoO₂, LiMn₂O₄, LiNiO₂, LiNi₁₋ₓCoₓO₂ (0<x<1), LiMnO₂, and so on have been researched.

Manganese-based positive active materials such as LiMn₂O₄ and LiMnO₂ are easy to synthesize, cost less than other materials, have excellent thermal stability compared to other active materials, and are environmentally friendly. However, these manganese-based materials have relatively low capacity.

LiCoO₂ has good electrical conductivity, a high cell voltage of about 3.7V, and excellent cycle-life, stability, and discharge capacity, and thus is a presently-commercialized representative material. However, LiCoO₂ is so expensive that makes up more than 30% of the cost of a battery, and thus may lose price competitiveness.

In addition, LiNiO₂ has the highest discharge capacity among the above positive active materials, but is hard to synthesize. Furthermore, since nickel is highly oxidized, it may deteriorate the cycle-life of a battery and an electrode, and may have a problem of severe self discharge and reversibility deterioration. Further, it may be difficult to commercialize due to incomplete stability.

### SUMMARY

One aspect of this disclosure is to provide an olivine-based positive active material having both the merits of economic, stable, high-capacity olivine-based positive active material and simultaneously of improving electrical conductivity and high rate characteristics.

According to one aspect, an olivine-based positive active material for a rechargeable lithium battery is provided that is represented by the following Chemical Formula 1.

LiₓM_{y}M′_{z}XO_{4-w}B_{w} [Chemical Formula 1]

In Chemical Formula 1, M and M′ are independently elements selected from the group consisting of Fe, Ni, Co, Mn, Cr, Zr, Nb, Cu, V, Mo, Ti, Zn, Al, Ga, Mg, B, and a combination thereof, X is an element selected from the group consisting of P, As, Bi, Sb, Mo, and a combination thereof, B is an element selected from the group consisting of F, S, and a combination thereof, 0<x≦1.2, 0.98≦y<1, 0<z≦0.02, and 0≦w≦0.5.

The M′ may be Co.

The X may be P.

The w may be 0.

The y and z may be in the following ranges: 0.99≦y<1 and 0<z≦0.01, respectively.

According to another aspect of the present embodiments, a rechargeable lithium battery is provided that includes a positive electrode, negative electrode, and a separator between the positive electrode and negative electrode, wherein the positive electrode includes a current collector and a positive active material layer disposed on the current collector, and the positive active material layer includes an olivine-based positive active material represented by the following Chemical Formula 1, a conductive material, and a binder.

LiₓM_{y}M′_{z}XO_{4-w}B_{w} [Chemical Formula 1]

In Chemical Formula 1, M and M′ are each independently elements selected from the group consisting of Fe, Ni, Co, Mn, Cr, Zr, Nb, Cu, V, Mo, Ti, Zn, Al, Ga, Mg, B, and a combination thereof, X is an element selected from the group consisting of P, As, Bi, Sb, Mo, and a combination thereof, B is an element selected from the group consisting of F, S, and a combination thereof, 0<x≦1.2, 0.98≦y<1, 0<z≦0.02, and 0≦w≦0.5.

The M′ may be Co.

The X may be P.

The w may be 0.

The y and z may be in the following ranges: 0.99≦y<1 and 0<z≦0.01, respectively.

The binder may include at least one selected from the group consisting of polyvinyl alcohol, carboxylmethylcellulose, hydroxypropylcellulose, diacetylcellulose, polyvinylchloride, carboxylated polyvinylchloride, polyvinylfluoride, polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon.

The conductive material may include at least one selected from the group consisting of natural graphite, artificial graphite, carbon black, acetylene black, ketjen black, a carbon fiber, copper, nickel, aluminum, silver, a metal fiber, and a polyphenylene derivative.

The separator is a single or multi layer selected from the group consisting of polyethylene, polypropylene, and polyvinylidene fluoride.

It may provide a rechargeable lithium battery using the olivine-based positive active material having both the merits of economic, stable, high-capacity and simultaneously of improving electrical conductivity and high rate characteristics.

### BRIEF DESCRIPTION OF THE DRAWINGS

FIG. 1 is a XRD analysis data of Example 1.

FIG. 2 is a XRD analysis data of Comparative Example 1.

FIG. 3 is a SEM photograph of Example 1.

FIG. 4 is a SEM photograph of Comparative Example 1.

FIG. 5 is rate characteristic results of coin cell according to Example 2.

FIG. 6 is rate characteristic results of coin cell according to Comparative Example 2.

FIG. 7 is rate characteristic results of coin cell according to Comparative Example 3.

### DETAILED DESCRIPTION

Example embodiments will hereinafter be described in detail. However, these embodiments are only examples, and the present embodiments are not limited thereto.

According to one embodiment, the olivine-based positive active material for a rechargeable lithium battery may be represented by the following Chemical Formula 1.

LiₓM_{y}M′_{z}XO_{4-w}B_{w} [Chemical Formula 1]

In Chemical Formula 1, M and M′ are each independently elements selected from the group consisting of Fe, Ni, Co, Mn, Cr, Zr, Nb, Cu, V, Mo, Ti, Zn, Al, Ga, Mg, B, and a combination thereof.

M′ may be Co. Co may be doped into the olivine-based positive active material so that a part of metals of the olivine-based positive active material may be substituted with Co. The rechargeable lithium battery using the Co-doped olivine-based positive active material may have a higher rate characteristic and the increased initial capacity.

In addition, the positive electrode using the Co-doped olivine-based positive active material may significantly improve the electrical conductivity. The rechargeable lithium battery using the positive electrode having the improved electrical conductivity may ensure the initial charge and discharge capacity and the charge and discharge capacity at a high rate.

X is an element selected from the group consisting of P, As, Bi, Sb, Mo, and a combination thereof, and B is an element selected from the group consisting of F, S, and a combination thereof. In some embodiments, X may be P.

In Chemical Formula 1, x, y, z and w may be in the following ranges:

0<x≦1.2, 0.98≦y<1, 0<z≦0.02, and 0≦w≦0.5

The lithium amount may be enlarged until the lithium rich range as understood in the range of x. In the case of lithium rich, it may substantially increase the theoretical capacity.

The ranges of y and z indicate that a part of metals is doped with M′ in the amount range of metal parts. The description about M′ will be omitted since Co is described as an example in above.

y may be 0.99≦y<1; z may be 0<z≦0.01. In some embodiments the range may be narrower as long as it may provide the same or higher effects as in the M′ doping effects.

In addition, as understood from the range of w, the oxygen atom part of olivine-based positive active material may be doped. However, it does not have to be doped. In some embodiments, w may be 0.

According to another embodiment, a rechargeable lithium battery includes a positive electrode, a negative electrode, and a separator between the positive electrode and negative electrode. The positive electrode includes a current collector and a positive active material layer disposed on the current collector, and the positive active material layer includes an olivine-based positive active material represented by the following Chemical Formula 1, a conductive material, and a binder.

LiₓM_{y}M′_{z}XO_{4-w}B_{w} [Chemical Formula 1]

The definitions of Chemical Formula 1 are the same as above.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. Structures and fabricating methods for lithium ion batteries pertaining to this disclosure are well known in the art.

The negative electrode includes a current collector and a negative active material layer disposed thereon, and the negative active material layer includes a negative active material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes a carbon material. The carbon material may be any generally-used carbon-based negative active material for a lithium ion rechargeable battery. Examples of the carbon material include crystalline carbon, amorphous carbon, or a mixture thereof. The crystalline carbon may be non-shaped, or sheet, flake, spherical, or fiber shaped natural graphite or artificial graphite. The amorphous carbon may be a soft carbon, a hard carbon, mesophase pitch carbonized products, fired coke, or the like.

Examples of the lithium metal alloy includes lithium and at least one metal selected from Na, K, Rb, Cs, Fr, Be, Mg, Ca, Sr, Si, Sb, Pb, In, Zn, Ba, Ra, Ge, Al, or Sn.

Examples of the material being capable of doping and dedoping lithium include Si, SiOₓ (0<x<2), a Si—Y alloy (where Y is an element selected from the group consisting of an alkaline metal, an alkaline-earth metal, a group 13 element, a group 14 element, a group 15 element, a group 16 element, a transition element, a rare earth element, and combinations thereof, and is not Si), Sn, SnO₂, a Sn—Y alloy (where Y is an element selected from the group consisting of an alkaline metal, an alkaline-earth metal, a group 13 element, a group 14 element, a group 15 element, a group 16 element, a transition element, a rare earth element, and combinations thereof, and is not Sn), and mixtures thereof. At least one of these materials may be mixed with SiO₂. The element Y is selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, or the like.

The negative active material layer includes a binder and optionally a conductive material.

The binder improves binding properties of the negative active material particles to each other and to a current collector, and includes polyvinyl alcohol, carboxylmethyl cellulose, hydroxypropyl cellulose, polyvinylchloride, carboxylated polyvinylchloride, polyvinylfluoride, polyethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, or nylon, but is not limited thereto.

The conductive material is included to improve electrode conductivity. Any electrically conductive material may be used as a conductive material unless it causes a chemical change. Examples of the conductive material include: carbon-based materials such as natural graphite, artificial graphite, carbon black, acetylene black, ketjen black, carbon fiber, and the like; metal-based materials including a metal powder or a metal fiber of copper, nickel, aluminum, silver, and the like; conductive polymers of polyphenylene derivatives; or mixtures thereof.

The current collector may be selected from a copper foil, a nickel foil, a stainless steel foil, a titanium foil, a nickel foam, a copper foam, a polymer substrate coated with a conductive metal, or a combination thereof.

The positive electrode includes a current collector and a positive active material layer disposed on the current collector

The positive active material layer includes a positive active material. Since the positive active material is the same as the embodiment described above, it is not described again hereafter.

The positive active material layer may include a binder and a conductive material.

The binder improves binding properties of the positive active material particles to each other and to a current collector. Examples of the binder include at least one selected from the group consisting of polyvinyl alcohol, carboxylmethyl cellulose, hydroxypropyl cellulose, polyvinyl chloride, carboxylated polyvinylchloride, polyvinylfluoride, polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but are not limited thereto.

The conductive material is included to improve electrode conductivity. Any electrically conductive material may be used as a conductive material unless it causes a chemical change. Examples of the conductive material include: a carbon-based material such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative; or mixtures thereof.

The current collector may include Al, but is not limited thereto.

The negative electrode and the positive electrode may be fabricated by mixing a negative active material, a conductive material, and a binder in a solvent to prepare an active material composition, and coating the composition on a current collector. The solvent may include N-methylpyrrolidone, or the like, but is not limited thereto.

The electrolyte may include a non-aqueous organic solvent and a lithium salt.

The non-aqueous organic solvent plays a role of transferring ions that are related to an electrochemical reaction of a battery.

The non-aqueous organic solvent may include carbonate-based, ester-based, ether-based, ketone-based, alcohol-based, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and examples of the ester-based solvent include methyl acetate, ethyl acetate, n-propyl acetate, dimethyl acetate, methylpropionate, ethylpropionate, γ-butyrolactone, decanolide, valerolactone, mevalonolactone, caprolactone, or the like. Examples of the ether-based solvent may include dibutyl ether, tetraglyme, diglyme, dimethoxyethane, 2-methyltetrahydrofuran, tetrahydrofuran, or the like, and examples of the ketone-based solvent may include cyclohexanone or the like. Examples of the alcohol-based solvent may include ethanol, isopropyl alcohol, and so on, and examples of the aprotic solvent may include R—CN (wherein R is a C₂ to C₂₀ linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or as a mixture. When the organic solvent is used as a mixture, the mixture ratio may be controlled in accordance with desirable battery performance.

The carbonate-based solvent may include a mixture of a cyclic carbonate and a linear carbonate. The cyclic carbonate and the linear carbonate are mixed together in a volume ratio of about 1:1 to about 1:9, and when the mixture is used as an electrolyte, the electrolyte performance may be enhanced.

In addition, the electrolyte of one embodiment may further include mixtures of carbonate-based solvents and aromatic hydrocarbon-based solvents. The carbonate-based solvents and the aromatic hydrocarbon-based solvents are mixed together in a volume ratio of about 1:1 to about 30:1.

The aromatic hydrocarbon-based organic solvent may be represented by the following Chemical Formula 2.

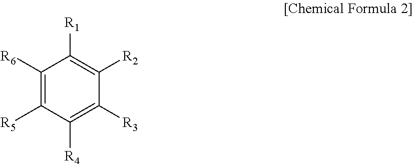

In Chemical Formula 2, R₁ to R₆ are the same or different, and are hydrogen, a halogen, a C₁ to C₁₀ alkyl, a C₁ to C₁₀ haloalkyl, or a combination thereof.

Examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-di iodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In order to improve a battery cycle-life, the non-aqueous electrolyte may further include vinylene carbonate or an ethylene carbonate-based compound of the following Chemical Formula 3.

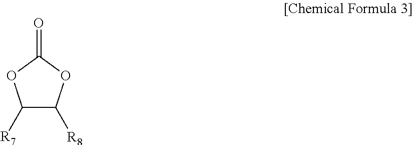

In Chemical Formula 3, R₇ and R₈ are the same or different, and are independently hydrogen, a halogen, a cyano group (CN), a nitro group (NO₂), or a C1 to C5 fluoroalkyl group, provided that at least one of R₇ and R₈ is halogen, a cyano group (CN), a nitro group (NO₂), or a C1 to C5 fluoroalkyl, and both R₇ and R₈ are not hydrogen.

The ethylene carbonate-based compound includes difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The use amount of the additive for improving cycle life may be adjusted within an appropriate range.

The lithium salt supplies lithium ions in the battery, and operates a basic operation of a rechargeable lithium battery and improves lithium ion transport between positive and negative electrodes. Non-limiting examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, and LiB(C₂O₄)₂ (lithium bisoxalato borate, LiBOB). The lithium salt may be used at a concentration of about 0.1 to about 2.0M. When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and polypropylene/polyethylene/polypropylene triple-layered separator.

The following examples illustrate the present embodiments in more detail. These examples, however, should not in any sense be interpreted as limiting the scope of the present embodiments.

### EXAMPLES

### Example 1

### Preparation of Positive Active Material

Lithium carbonate as a Li raw material, iron oxalate as a Fe raw material, a diammonium phosphate as a P raw material, and Co nitrate as a Co raw material are introduced into a ball mill process. When the raw materials are mixed, the Co raw material and the Fe raw material are mixed to provide a mole ratio of included Fe and Co atoms with Fe:Co=0.99:0.01.

The ball mill process is a process using ethanol, and it is performed for about 49 hour to about 50 hour.

After the ball mill process, the simply mixed raw materials are dried at about 100° C. under the air atmosphere to evaporate the remained organic alcohol.

After the drying process, sucrose is added and mixed in about 5 wt % based on the total weight of the resulting material to provide a carbon coating on the surface.

Then it is heated at about 700° C. for about 10 hours under the reduction atmosphere including 95 volume of N₂ and 5 volume of H₂ to provide a positive active material represented by LiFe_{0.99}CO_{0.01}PO₄.

### Comparative Example 1

### Preparation of Positive Active Material

Lithium carbonate as a Li raw material, iron oxalate as a Fe raw material, and diammonium phosphate as a P raw material are introduced into a ball mill process.

The ball mill process is a process using organic alcohol, and it is performed for about 48 hours or longer.

After the ball mill process, the simply mixed raw materials are dried at about 100° C. under the nitrogen atmosphere or the air atmosphere to evaporate the remained organic alcohol.

After the drying process, sucrose is added and mixed in about 5 wt % based on the total weight of the resulting material to provide a carbon coating on the surface.

Then it is heated at about 700° C. for about 10 hours under the reduction atmosphere including 95 volume of N₂ and 5 volume of H₂ to provide a positive active material that iron lithium phosphate (LiFePO₄) is chemically produced.

### Example 2

### Fabrication of Coin Cell

### Fabrication of Positive Electrode

The positive active material obtained from Example 1, a binder of polyvinylidene fluoride, and a conductive material of carbon black are mixed in a weight ratio of 90:5:5 in a Nmethylpyrrolidone solvent to provide a positive active material layer slurry. The positive active material layer slurry is coated on Al foil as a positive electrode current collector to provide a thin electrode plate, and then it is dried at about 120° C. for about 1 hour and pressed to provide a positive electrode including a positive active material layer.

### Fabrication of Negative Electrode

A negative electrode is fabricated using a negative active material of Li Foil.

### Fabrication of Battery Cell

The obtained positive electrode, the negative electrode, a polyethylene separator having a thickness of 20 μm, and an electrolyte solution (1.15M LiPF₆ dissolved in a mixture of EC (ethylene carbonate), EMC (ethylmethyl carbonate), and DMC (dimethyl carbonate) (volume ratio of EM:EMC:DMC is 3:3:4)) are assembled to provide a coin cell.

### Comparative Example 2

### Fabrication of Coin Cell

A coin cell is fabricated in accordance with the same procedure as in Example 2, except that the positive active material obtained from Comparative Example 1 is used instead of the positive active material obtained from Example 1

### Comparative Example 3

A coin cell is fabricated in accordance with the same procedure as in Example 2, except that LiFe_{0.95}CO_{0.05}PO₄ as the positive active material is used instead of the positive active material obtained from Example 1.

### Experimental Example

### XRD Analysis

XRD Experiment condition

Step size: 0.02 theta

Step time: 0.05 second

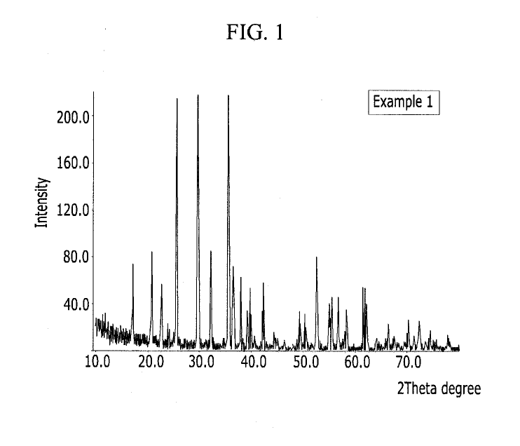

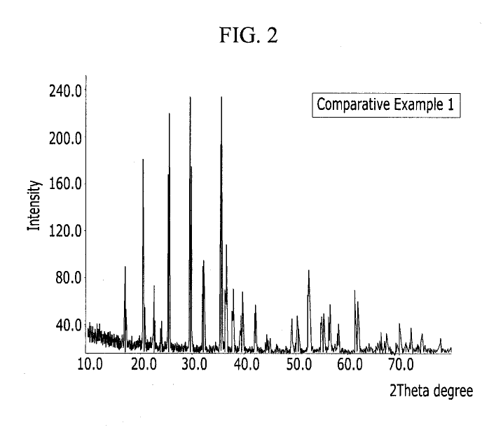

FIG. 1 is a XRD analysis data using CuKα of Example 1; and FIG. 2 is a XRD using CuKα analysis data of Comparative Example 1.

From the comparison of FIG. 1 with FIG. 2, Co doping results are obtained from two peaks or area of 2θ=40−45 in FIG. 1.

### SEM Photographs

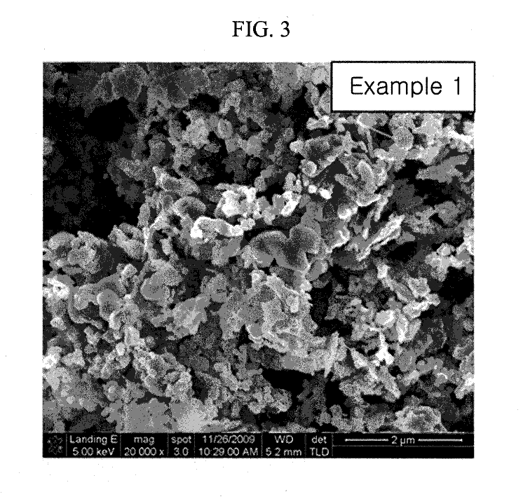

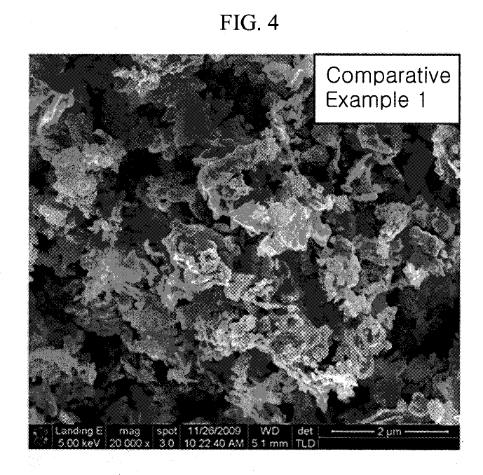

FIG. 3 is a SEM photograph of Example 1; and FIG. 4 is a SEM photograph of Comparative Example 1.

From the results of FIG. 3 and FIG. 4, it is understood that the positive active material according to Example 1 that a part of Co is doped is uniformly formed as in the positive active material according to Comparative Example 1.

### Cell Characteristics

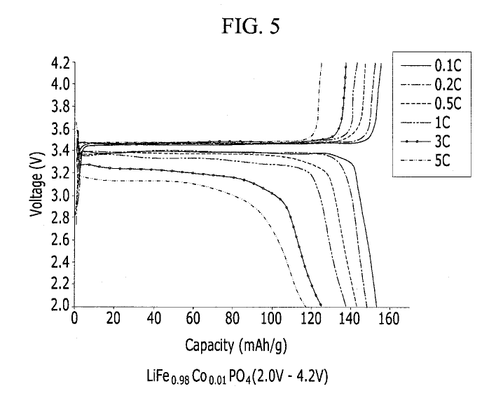

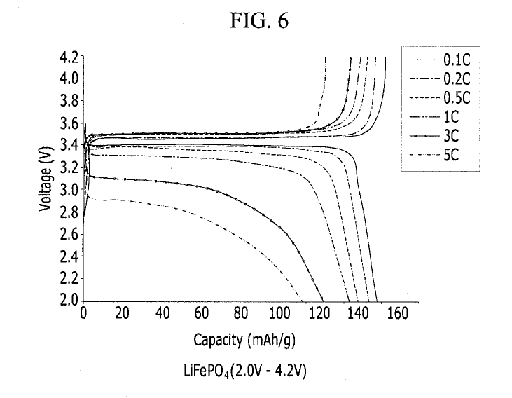

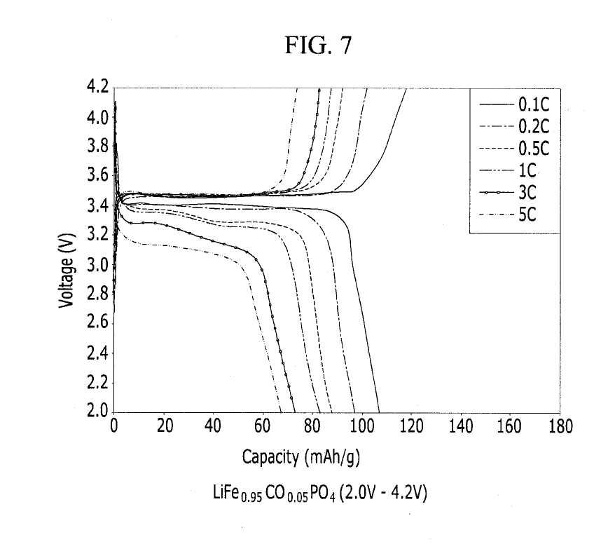

FIG. 5 is the rate characteristic results of coin cell obtained from Example 2; FIG. 6 is the rate characteristic graph of coin cell obtained from Comparative Example 2, and FIG. 7 is the rate characteristic graph of coin cell obtained from Comparative Example 3.

From the graph results, it is understood that the conductivity is improved by adding Co, so the voltage is steadily maintained according to performing the charge and discharge to provide a higher charge and discharge capacity.

While this disclosure has been described in connection with what is presently considered to be practical example embodiments, it is to be understood that this disclosure is not limited to the disclosed embodiments, but, on the contrary, is intended to cover various modifications and equivalent arrangements included within the spirit and scope of the appended claims. Therefore, the above-mentioned embodiments are examples but do not limit in any sense.

What is claimed is:

1. An olivine-based positive active material for a rechargeable lithium battery represented by the following Chemical Formula 1:
LiₓM_{y}M′_{z}XO_{4-w}B_{w} [Chemical Formula 1]
wherein, M and M′ are each independently elements selected from the group consisting of Fe, Ni, Co, Mn, Cr, Zr, Nb, Cu, V, Mo, Ti, Zn, Al, Ga, Mg, B, and a combination thereof, X is an element selected from the group consisting of P, As, Bi, Sb, Mo, and a combination thereof, B is an element selected from the group consisting of F, S, and a combination thereof, 0<x≦1.2, 0.98≦y<1, 0<z≦0.02, and 0≦w≦0.5.

2. The olivine-based positive active material of claim 1, wherein M′ is Co.

3. The olivine-based positive active material of claim 1, wherein X is P.

4. The olivine-based positive active material of claim 1, wherein w is 0.

5. The olivine-based positive active material of claim 1, wherein M′ is Co and w is 0.

6. The olivine-based positive active material of claim 1, wherein M′ is Co and X is P.

7. The olivine-based positive active material of claim 1, wherein X is P and w is 0.

8. The olivine-based positive active material of claim 1, wherein M′ is Co, X is P and w is 0.

9. The olivine-based positive active material of claim 1, wherein y and z are in the following ranges: 0.99≦y<1 and 0<z≦0.01, respectively.

10. A rechargeable lithium battery, comprising:
a positive electrode, negative electrode, and a separator between the positive electrode and negative electrode,
wherein the positive electrode comprises a current collector and a positive active material layer disposed on the current collector, and the positive active material layer comprises an olivine-based positive active material represented by the following Chemical Formula 1, a conductive material, and a binder:
LiₓM_{y}M′_{z}XO_{4-w}B_{w} [Chemical Formula 1]
wherein, M and M′ are each independently elements selected from the group consisting of Fe, Ni, Co, Mn, Cr, Zr, Nb, Cu, V, Mo, Ti, Zn, Al, Ga, Mg, B, and a combination thereof, X is an element selected from the group consisting of P, As, Bi, Sb, Mo, and a combination thereof, B is an element selected from the group consisting of F, S, and a combination thereof, 0<x≦1.2, 0.98≦y<1, 0<z≦0.02, and 0≦w≦0.5.

11. The rechargeable lithium battery of claim 10, wherein M′ is Co.

12. The rechargeable lithium battery of claim 10, wherein X is P.

13. The rechargeable lithium battery of claim 10, wherein w is 0.

14. The rechargeable lithium battery of claim 10, wherein y and z are in the following ranges: 0.99≦y<1 and 0<z≦0.01, respectively.

15. The rechargeable lithium battery of claim 10, wherein the binder comprises at least one selected from the group consisting of polyvinyl alcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon.

16. The rechargeable lithium battery of claim 10, wherein the conductive material comprises at least one selected from the group consisting of natural graphite, artificial graphite, carbon black, acetylene black, ketjen black, a carbon fiber, copper, nickel, aluminum, silver, a metal fiber, and a polyphenylene derivative.

17. The rechargeable lithium battery of claim 10, wherein the separator is a single or multiple layer selected from the group consisting of polyethylene, polypropylene, and polyvinylidene fluoride.

18. The rechargeable lithium battery of claim 10, wherein M′ is Co and w is 0.

19. The rechargeable lithium battery of claim 10, wherein M′ is Co and X is P.

20. The rechargeable lithium battery of claim 10, wherein M′ is Co, X is P and w is 0.
